(19) United States
(12) Patent Application Publication
(10) Pub. No.: US 2024/0367530 A1
(43) Pub. Date: Nov. 7, 2024

(54) BOOSTER FUNCTIONALITY FOR A CHARGING STATION FOR CHARGING ELECTRIC VEHICLES

(71) Applicant: Adaptive Balancing power GMBH [DE/DE], Pfungstat (DE)

(72) Inventor: Hendrik SCHAEDE-BODENSCHATZ, Pfungstat (DE)

(73) Assignee: Adaptive Balancing power GMBH [DE/DE], Pfungstat (DE)

(21) Appl. No.: 18/688,874

(22) PCT Filed: Sep. 8, 2022
(86) PCT No.: PCT/EP2022/075034

§ 371 Date: Mar. 4, 2024

(30) Foreign Application Priority Data
Sep. 8, 2021 (DE) 10 2021 209 916.5

(51) Int. Cl. B60L 53/10; B60L 53/16; B60L 53/56; B60L 53/62

(52) U.S. Cl. CPC B60L 53/11; B60L 53/16; B60L 53/56; B60L 53/62

(57) ABSTRACT

A charging station for charging electric vehicles, having a connection unit for connecting the charging station to an electrical supply infrastructure and for supplying the charging station with electrical supply current; at least two direct current voltage sources, at least one of which is electrically coupled to the connection unit in order to be supplied with the electrical supply current by the connection unit, and which are configured to provide a proportionate electrical power for charging at least one electric vehicle by means of a direct current charging voltage which can be set in a respective direct current charging voltage range; a coupling unit for temporarily coupling the electric vehicle to at least one of the DC voltage sources; and a control unit for adjusting the DC charging voltages of the DC voltage sources and for connecting the DC voltage sources to the coupling unit depending on a voltage requirement.

The invention relates to a charging station for charging electric vehicles, having a connection unit for connecting the charging station to an electrical supply infrastructure and for supplying the charging station with electrical supply current, having at least two DC voltage sources, at least one of which is electrically coupled to the connection unit in order to be supplied with the electrical supply current by the connection unit, and which are configured for charging the at least one electric vehicle by means of a DC charging voltage which can respectively be set in a DC charging voltage range assigned to the respective DC voltage source, with at least one coupling unit for temporarily electrically coupling the at least one electric vehicle to at least one of the DC voltage sources and with a control unit for setting the DC charging voltages of the DC voltage sources and for connecting the DC voltage sources to the coupling unit depending on a power and/or voltage requirement of the at least one electric vehicle for charging. The invention also relates to a corresponding method.

In accordance with the Combined Charging System (CCS) standard, electric vehicles, or more precisely battery electric vehicles (BEVs), can be charged with up to 350 kW. A standard-compliant charging station must be able to provide a DC charging voltage in a DC charging voltage range between 200 V and 1,000 V, i.e. to provide a DC charging voltage of any amount within this DC charging voltage range depending on a corresponding request signal from the electric vehicle. The DC charging voltage required by the electric vehicle, i.e. the associated vehicle drive battery, and requested for charging depends on the type of battery and its state of charge and is therefore set dynamically. High-voltage battery systems used in existing electric vehicles, for example, have a final charging voltage of 750 volts. Particularly high power can usually be transferred to batteries in the range between 20 and 80% of the state of charge.

Charging stations for charging electric vehicles are often made up of several small, identical DC voltage sources, especially if they are to provide a high output. These are connected by means of direct current (DC) contactors in such a way that the total charging power called up by the electric vehicle is provided with the respective proportionate charging power of one or more of the direct current voltage sources. Such a system is described, for example, in DE 20 2019 105 511 U1. Furthermore, it is possible to use a switching matrix to connect such DC voltage sources to different charging points depending on the situation in order to meet different charging requirements of different electric vehicles at different charging points at a charging station. The available charging power is thus managed situationally by means of a control unit, which ensures efficient utilization of the available hardware and power. For example, it is known from DE 10 2009 055 845 A1 that a charging station for supplying electrically powered vehicles with electrical energy can contain a flywheel storage unit as an intermediate storage unit for electrical energy.

The task is therefore to simplify the design of the charging stations and improve their efficiency, particularly in conformity with the relevant standards.

This task is fulfilled by the objects of the independent patent claims. Advantageous embodiments are shown in the dependent patent claims, the description and the figures.

One aspect relates to a charging station for charging electric vehicles, for example passenger cars, trucks, buses, construction site vehicles, agricultural or other commercial vehicles, ships, drones and/or electric aircraft. The charging station has a connection unit for connecting the charging station to an electrical supply infrastructure, for example a public power grid or a local supply infrastructure such as a solar cell park, and for supplying the charging station with electrical supply current. In particular, the supply current can be a supply current with an alternating voltage.

The charging station also has at least two, i.e. two or more, DC voltage sources, at least one, i.e. one or more, in particular all, of which is at least temporarily coupled to the connection unit during intended use in order to be supplied with the electrical supply current by the connection unit. DC voltage sources that are not coupled or can be coupled to the connection unit, for example those that have an energy storage device, can be charged via the grid-connected DC voltage source or one of the grid-connected DC voltage sources, for example when no electric vehicle is being charged, and thus be supplied with the electrical supply current. The DC voltage sources are designed to provide a proportionate electrical power for charging at least one electric vehicle by means of a DC charging voltage that can be set in a DC charging voltage range assigned to the respective DC voltage source. Since the DC voltage sources thus provide the DC voltage used for charging the electric vehicle, no DC/DC converter is connected between the DC voltage sources and the electric vehicle to be charged. Accordingly, the charging station does not require a direct current/direct current (DC/DC) converter shared by different direct current voltage sources, so preferably does not have such a shared direct current/direct current (DC/DC) converter. One or more electric vehicles can therefore be charged simultaneously or staggered, whereby a total power resulting from the sum of the proportionate power provided by the DC voltage sources is then distributed to the one or more electric vehicles.

The charging station also has at least one coupling unit, i.e. one or more coupling units, for temporarily electrically coupling the at least one electric vehicle to at least one of the DC voltage sources. Accordingly, if an electric vehicle coupled to the charging station with the coupling unit is to be charged with a total power which exceeds a proportionate/partial electrical power of a direct current voltage source, several of the direct current voltage sources are electrically coupled to the coupling unit so that their respective proportional powers together result in the required total power for charging the electric vehicle.

The charging station also has a control unit for setting the DC charging voltages of the DC voltage sources and for connecting the DC voltage sources to the coupling unit depending on a power and/or voltage requirement of the at least one electric vehicle for the charging. Accordingly, the DC voltage sources can also be connected in particular in such a way that they provide respective proportionate/partial voltages of a total voltage which is required for charging the at least one electric vehicle. Accordingly, the control unit achieves a demand-dependent dynamic connection of the direct current voltage sources so that, as described above, the respective proportionate powers, in particular also the respective proportionate voltages, of the individual direct current voltage sources can be combined as required in order to charge the electric vehicle.

There, the DC charging voltage range of at least one of the DC voltage sources, which is accordingly referred to as a booster DC voltage source, is permanently different from the DC charging voltage range of at least one of the at least one other DC voltage sources, which is referred to as a standard DC voltage source, i.e. different when the DC voltage sources are used as intended. The DC charging voltage ranges are therefore distinct or differently specified. The DC charging voltage range of the standard DC voltage source is at least partially outside the DC charging voltage range of the booster DC voltage source, so there is a DC voltage range which is in the DC charging voltage range of the standard DC voltage source but not in the DC charging voltage range of the booster DC voltage source. The DC charging voltage range of the booster DC voltage source, in which the DC charging voltage provided by the booster DC voltage source can be set, is preferably a DC voltage range that is above a limit of 500 V, in particular above a limit of 600 V. The different DC charging voltage ranges can be specified by design, for example by a technical specification of the elements used in the DC voltage sources for the respective DC charging voltage ranges. Alternatively or additionally, different DC charging voltage ranges can also be specified by a corresponding logical regulation, for example by limit values for the respective DC charging voltage ranges stored in firmware or the like.

The control unit, in turn, is configured to connect the booster DC voltage source exclusively to the coupling unit used for the respective charging, i.e. to use the proportionate power of the booster DC voltage source for charging the respective electric vehicle, if a voltage is set at the coupling unit for charging the at least one electric vehicle which is in the DC charging voltage range of the booster DC voltage source. The voltage for charging the electric vehicle can be set depending on (as a function of) a request signal from the electric vehicle, in particular taking into account a state of the charging station, for example the amount of electrical supply current available via the connection unit, a charging activity of the charging station for other electric vehicles and/or a charging state of an energy storage device of the charging station.

In particular, the control unit can be designed to only connect the booster DC voltage source(s) to the coupling unit used for the respective charging if a fast charging mode, a “booster mode”, is activated for charging the respective electric vehicle. In a standard charging mode, it is therefore possible to connect only the standard DC voltage source(s) to the coupling unit used for the respective charging. For example, the DC charging voltage range of the standard DC voltage source(s) can contain the DC charging voltage range of the booster DC voltage source(s), so that any voltage that can be generated by the booster DC voltage source(s) can also be generated by the standard DC voltage source(s), can also be generated by the standard DC voltage source(s), but the booster DC voltage source(s) is only switched on selectively as described depending on the selected mode, but as described only if the voltage with which charging takes place is within the range of the adjustable voltage of the booster voltage source.

One finding underlying the invention is that when vehicle batteries can absorb particularly high power, i.e. typically have a state of charge between 20 and 80%, the required charging voltage is in a significantly smaller voltage window than the standard specifies. This in turn is basis for the realization that it is not efficient to maintain a maximum charging power over a large voltage range, for example the 200 to 1000 V mentioned in the relevant CCS standard. Rather, the charging station described makes it possible to implement high performance in a specific DC charging voltage range, namely the DC charging voltage range of the booster DC voltage source, and to implement a lower available charging power in other DC charging voltage ranges in which the vehicle batteries can only absorb a lower power anyway.

Accordingly, as described below, one or more booster DC voltage sources can also be assigned to different coupling units for parallel or consecutive charging of different electric vehicles depending on demand. In particular, booster and standard DC voltage sources can also be based on different technologies so that the most efficient technology or design can be selected for the different DC charging voltage ranges. The deliberate use of different DC voltage sources, which requires a more sophisticated interconnection of the DC voltage sources when charging the electric vehicles by the control unit, thus also enables the use of more efficient voltage sources, in particular the use of DC voltage sources whose respective switching elements are optimized for specific different DC charging voltage ranges and are therefore less complex, in particular more robust and more efficient. However, the fact that the different DC voltage sources together cover a larger DC charging voltage range than that of the booster DC voltage source means that a large DC charging voltage range, in particular the entire charging voltage range of the relevant standards, can also be covered with the respective specialized and optimized DC voltage sources.

In an advantageous embodiment, it is provided that the DC charging voltage range of the booster DC voltage source is a range below 850 V, preferably below 801 V. In particular, the DC charging voltage range of the booster DC voltage source can be in the range between 500 and 801 V, preferably in the range between 600 V and 801 V. This has the advantage that the DC charging voltage range of the booster DC voltage source lies precisely in the range in which particularly high power can be transferred to the vehicle batteries due to the technical implementation in the vehicles, which are compliant with the CCS standard valid in July 2021.

Alternatively, for example if the at least one booster DC voltage source has several sub-booster DC voltage sources which are connected together for charging, the same as described in the last paragraph can apply to the respective sub-booster DC voltage sources, so that the DC charging voltage range of the sub-booster DC voltage sources as a whole, which are jointly connected as a (meta-) booster DC voltage source for charging, is a range below 1650 V, preferably below 1601 V, or a range below 2450 V, preferably 2401 V. For example, the range in the first case (in which, for example, two sub-booster DC voltage sources are connected in series to form a (meta-) booster DC voltage source) can be in the range between 1000 V and 1601 V, preferably in the range between 1200 V and 1601 V, and in the second case (in which, for example, three sub-booster DC voltage sources are connected in series to form a (meta-) booster DC voltage source) in a range between 1500 V and 2401 V, preferably between 1800 V and 2401 V. This has the advantage that the benefits explained in the last paragraph for the current CCS standard are also achieved for charging systems with higher outputs (and voltages), in particular the higher charging voltages expected to be possible in accordance with the future Megawatt Charging Solution standard, the MCS standard.

In a further advantageous embodiment, the DC charging voltage range of the booster DC voltage source is smaller than the DC charging voltage range of the standard DC voltage source. In particular, as mentioned above, the DC charging voltage range of the booster DC voltage source can also be a sub-range of the DC charging voltage ranges of the standard DC voltage sources. This has the advantage that a DC charging voltage range covered by the standard DC voltage source can be selectively and thus efficiently supplemented by the booster voltage source, whereby the aforementioned advantages can be achieved in a particularly simple and standard-compliant manner.

In a further advantageous embodiment, it may be provided that the booster DC voltage source has an energy storage device, which in particular comprises or is a flywheel mass storage device. By an energy storage device is meant here a device for storing energy, which can provide a peak power over a period of at least 10 seconds, in particular at least 60 seconds, and thus has a so-called call-up duration of at least 10 seconds or at least 60 seconds at full power. Capacitive elements, such as those implemented in large numbers in conventional electrical control units, are therefore not to be understood as energy storage devices within the meaning of the invention, and other components which store energy that is not intended for charging the electric vehicle are therefore also not to be regarded as energy storage devices. This has the advantage that charging capacities that are (significantly) higher than the connected load of the supply infrastructure can be provided. Flywheel mass storage systems are particularly well suited as power storage systems here, as they are suitable for providing a large electrical power, just as the booster DC voltage source should provide in order to be able to transfer a particularly large power to the vehicle battery. The limited DC charging voltage range of the booster DC voltage source enables a particularly simple technical implementation with the flywheel mass storage system, in particular the number of DC/DC converters required can be reduced.

Accordingly, the control unit can be configured to store electrical energy in the respective energy storage device(s) depending on a supply infrastructure operator signal. In other words, depending on availability in the supply infrastructure, the energy storage unit can serve as a buffer storage unit.

In a further advantageous embodiment, it is provided that at least one of the standard DC voltage sources also comprises an energy store, in particular all standard DC voltage sources comprise an energy store, whereby the store or stores of the standard DC voltage sources preferably has a lower retrievable power than the energy store of the booster DC voltage source. This has the advantage that the respective energy storage units are optimized for their respective application scenario, i.e. the energy storage unit of the booster DC voltage source is configured to transfer a particularly high power to the vehicle batteries, as is to be expected in the associated voltage window, the DC charging voltage range of the booster DC voltage source when used as intended. This in turn allows the individual units to be specifically adapted to their respective operating conditions.

In another advantageous embodiment, it is provided that several coupling units are present, and the control unit is configured to connect the at least one booster DC voltage source to the different coupling units depending on a respective power and/or voltage requirement of respective electric vehicles coupled to different coupling units for charging. This allows particularly efficient use of the booster DC voltage source.

In a further advantageous embodiment, it is provided that several booster DC voltage sources are present and the control unit is configured to connect the booster DC voltage sources, either in series depending on the respective (different or identical) DC charging voltage ranges of the booster DC voltage sources and the power and/or voltage requirements for the charging in one or more different predetermined configurations, and thus create a higher-level booster DC voltage source, a meta-booster DC voltage source, and/or connect them in parallel in one or more different configurations, and/or connect them partly in series and partly in parallel in one or more different configurations to provide at the one or more coupling points a power and/or a voltage corresponding to the respective power and/or voltage demand. This has the advantage that the charging station can be used particularly flexibly and at the same time the different booster DC voltage sources can be used particularly effectively for charging the electric vehicles.

In a further advantageous embodiment, it is provided that the control unit is configured to (in a booking mode) connect the booster DC voltage source during a charging operation of the charging station in which the electric vehicle is being charged and/or during a preparatory operation of the charging station in which no electric vehicle is being charged, in which no electric vehicle is being charged, in such a way that at a later time, which can be predetermined or specified by a user or interface signal, a quantity of energy that can also be predetermined by the signal is deliverable or retrievable (can be called up) for charging another electric vehicle in one or the energy store of the booster DC voltage source. This has the advantage that energy quantities can be reliably available at a reserved time, so that defined energy quantities can be booked in the charging station for future times, so that charging times can be reduced accordingly.

Therein, the control unit can be configured to keep the predeterminable amount of energy available or deliverable by connecting the booster DC voltage source in charging operation (when booking mode is activated) in such a way that the amount of energy stored in the energy storage unit does not fall below the predeterminable amount of energy until the later point in time. This means that the desired amount of energy can actually be called up at the later point in time with a high degree of certainty and little effort.

In a further advantageous embodiment, it can also be provided that the control unit is configured to (when the booking mode is activated) use statistical data on the use of the charging station for charging electric vehicles and on a quantity of the supply current available via the electrical supply infrastructure to keep the predeterminable amount of energy available for delivery or retrieval, in particular in such a way that a predeterminable confidence is achieved for the availability of the predeterminable amount of energy at the predeterminable later time. For example, it is thus possible to determine with a confidence or reliability of 98% what proportion of the power from the booster DC voltage source can still be called up for the charging of electric vehicles that takes place in the meantime up to the predeterminable later point in time, given an available quantity of the supply current available via the electrical supply infrastructure that can be expected with corresponding certainty and corresponding expected use of the charging station, in order to still have the predeterminable quantity of energy available at the later point in time. This further increases the efficiency of the charging station operation, as the stored and thus available energy quantities are not rigidly reserved, but can still be used in the meantime until the planned use.

A further aspect relates to a method for charging at least one electric vehicle by means of a charging station having at least two DC voltage sources, which are configured or designed to provide an proportionate electrical power for charging the electric vehicle by means of a respective DC charging voltage in a DC charging voltage range, wherein the DC charging voltages of the DC voltage sources are set for charging and the DC voltage sources are connected for charging depending on a power and/or voltage requirement of the electric vehicle for charging. Therein, the DC charging voltage range of at least one of the DC voltage sources, a booster DC voltage source, is different from the DC charging voltage range of at least one of the at least one other DC voltage source, a standard DC voltage source, with the DC charging voltage range of the standard DC voltage source lying at least partially outside the DC charging voltage range of the booster DC voltage source. A method step is a connecting of the booster DC voltage source including a providing of the proportionate power assigned to the booster DC voltage source for charging the electric vehicle, which takes place exclusively when a voltage is set for charging the electric vehicle which is in the DC charging voltage range of the booster DC voltage source.

Advantages and advantageous embodiments of the method correspond to advantages and advantageous embodiments of the charging station here.

The features and combinations of features mentioned above in the description, also in the introductory part, as well as the features and combinations of features mentioned below in the description of the figures and/or shown alone in the figures can be used not only in the combination indicated in each case, but also in other combinations, without going beyond the scope of the invention. Thus, embodiments which are not explicitly shown and explained in the figures, but which emerge from the explained embodiments and can be produced by separate combinations of features, are also to be regarded as comprised and disclosed by the invention. Embodiments and combinations of features are also to be regarded as disclosed which thus do not have all the features of an originally formulated independent claim. Furthermore, embodiments and combinations of features are to be regarded as disclosed, in particular by the embodiments set out above, which go beyond or deviate from the combinations of features set out in the references of the claims.

With reference to the schematic drawings shown in the following figures, the object according to the invention will be explained in more detail, without wishing to limit it to the specific embodiments shown here.

Therein:

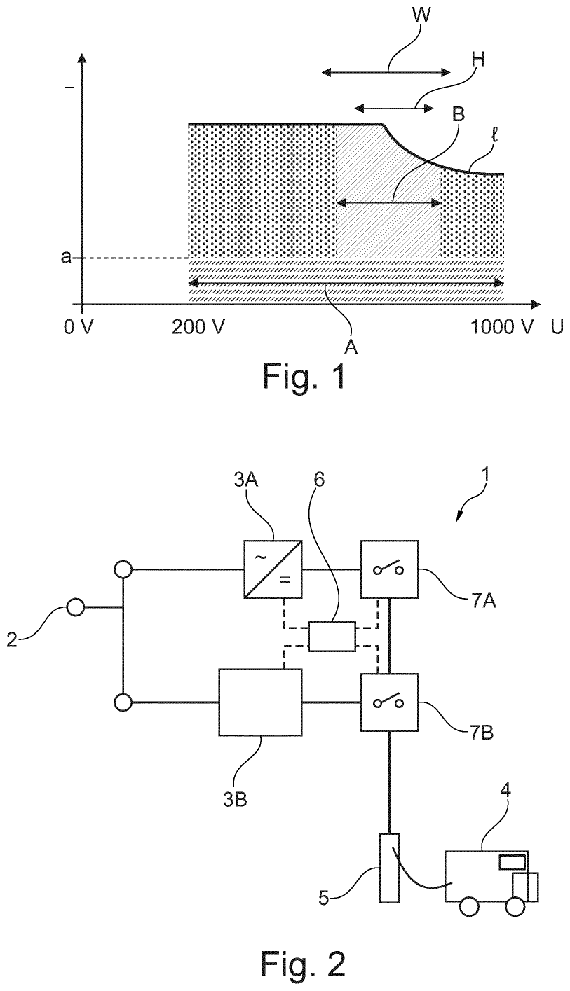

FIG. 1a shows current-voltage diagram that relates exemplary DC charging voltage ranges to the CCS standard;

FIG. 2 shows an exemplary embodiment of a charging station; and

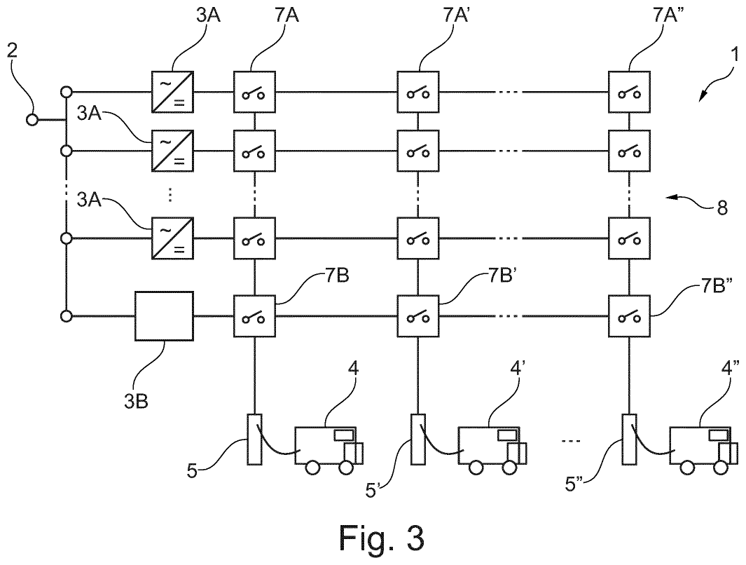

FIG. 3 shows another exemplary embodiment of a charging station.

Identical or functionally identical elements are provided with the same reference symbols in the different figures.

FIG. 1 shows an exemplary upper current limit I for an exemplary embodiment of a charging station. In the example shown, the voltage range of 200 V to 1000 V prescribed by the CCS standard is completely covered by a DC charging voltage range A of a standard DC voltage source 3A (FIG. 2). However, in the example shown, the standard DC voltage source can only provide a current up to a maximum current a. The DC charging voltage range B of a booster DC voltage source 3B (FIG. 2), on the other hand, is considerably smaller in the present case, even smaller than the DC operating range W of a high-voltage vehicle battery of a motor vehicle 4 to be charged (FIG. 2). At the same time, however, the DC charging voltage range B covers the DC charging voltage range H, in which the vehicle battery can be charged with a particularly high power. Accordingly, the booster DC voltage source with the DC charging voltage range B up to the limit current I can also cover all currents above the maximum current a applicable to the standard DC voltage source. The booster DC voltage source can therefore be used to charge particularly efficiently and quickly in the DC charging voltage range.

FIG. 2 shows an exemplary embodiment of a charging station for charging electric vehicles. The charging station 1 has a connection unit 2 for connecting the charging station 1 to an electrical supply infrastructure and for supplying the charging station 1 with electrical supply current. Furthermore, it has at least two, in the present case exactly two, direct current voltage sources 3A, 3B, of which at least one, in the present case both, are electrically coupled to the connection unit 2 in order to be supplied with the electrical supply current by the connection unit 2. The two DC voltage sources 3A, 3B are configured to provide an electrical proportionate power for charging an electric vehicle 4 in order to charge the at least one electric vehicle 4 by means of a DC charging voltage that can be set in a respective DC charging voltage range A, B (FIG. 1).

Furthermore, the charging station 1 has a coupling unit 5 for temporary electrical coupling of the electric vehicle 4 with at least one of the DC voltage sources 3A, 3B. The charging station also has a control unit 6 for setting the DC charging voltages of the DC voltage sources 3A, 3B and for connecting the DC voltage sources to the coupling unit 5, depending on a power and/or voltage requirement of the electric vehicle 4 for charging. Connecting or switching is carried out here via corresponding DC contactors 7A, 7B. The control unit 6 can also be electrically coupled to the electric vehicle, for example by wire via the coupling unit 5 or wirelessly, in order to query the power and/or voltage requirement of the electric vehicle 4 for charging via a data channel.

Therein, the DC charging voltage range B (FIG. 1) of at least one of the DC voltage sources 3B, a booster DC voltage source, is different from the DC charging voltage range A of at least one of the other DC voltage sources 3A, a standard DC voltage source. The DC charging voltage range A lies at least partially outside the DC charging voltage range B. The control unit 6 is configured to connect the booster DC voltage source 3B to the coupling unit 5 only when a voltage is set at the coupling unit 5 for charging the electric vehicle 4 which lies in the DC charging voltage range B of the booster DC voltage source 3A.

FIG. 3 shows a further exemplary embodiment of a charging station. This is designed in accordance with the charging station shown in FIG. 1, but in this case has a plurality of standard DC voltage sources 3A, as well as a plurality of coupling units 5, 51, 5″, via each of which a plurality of electric vehicles 4, 4′, 4″ can be electrically coupled to the charging station. Via an array 8 of a plurality of DC contactors 7A, 7A′, 7A″, 7B, 7B′, 7B″, a booster DC voltage source 3B can be connected to the plurality of standard DC voltage sources 3A depending on the respective DC charging voltage ranges A, B and the power and/or voltage requirement in different configurations in series, in parallel, or partly in series and partly in parallel, in order to provide a power or a voltage corresponding to the power requirement at the coupling point or points 5, 5′, 5″. As an alternative to the embodiment shown, several booster DC voltage sources 3B can also be provided in the charging station 1 and, instead of the several standard DC voltage sources 3A shown, only a single standard DC voltage source 3A can be provided.

1. A charging station (1) for charging electric vehicles (4), comprising:
a connection unit (2) for connecting the charging station (1) to an electrical supply infrastructure and for supplying the charging station (1) with electrical supply current;
at least two DC voltage sources (3A, 3B), at least one of which is electrically coupled to the connection unit (2) in order to be supplied with the electrical supply current by the connection unit (2), and which are configured to provide an proportionate electrical power for charging at least one electric vehicle (4) by means of a DC charging voltage which can be set in a respective DC charging voltage range (A, B);
a coupling unit (5) for temporarily electrically coupling the electric vehicle (4) to at least one of the DC voltage sources (3A, 3B); and
a control unit (6) for adjusting the DC charging voltages of the DC voltage sources (3A, 3B) and for connecting the DC voltage sources (3A, 3B) to the coupling unit (5) depending on a power or voltage requirement of the electric vehicle (4) for charging;
characterized in that
the DC charging voltage range (B) of at least one of the DC voltage sources (3B), a booster DC voltage source, differs from the DC charging voltage range (A) of at least one of the at least one other DC voltage source (3A), a standard DC voltage source, wherein the DC charging voltage range (A) of the standard DC voltage source (3A) is at least partially outside the DC charging voltage range (B) of the booster DC voltage source (3B); and
the control unit (6) is configured to connect the booster DC voltage source (3B) to the coupling unit (5) exclusively when a voltage is set at the coupling unit (5) for charging the electric vehicle (4) which is in the DC charging voltage range (B) of the booster DC voltage source (3B).

2. The charging station (1) of claim 1,
characterized in that
the DC charging voltage range (B) of the booster DC voltage source (3B) is a range below 850V, preferably below 801V, in particular in the range between 500V and 801V, preferably in the range between 600V and 801V.

3. The charging station of claim 2,
characterized in that
the DC charging voltage range (B) of the booster DC voltage source (3B) is smaller than the DC charging voltage range (A) of the standard DC voltage source (3A).

4. The charging station of claim 3,
characterized in that
a plurality of coupling units (5, 5′, 5″) are present, and the control unit (6) is configured to connect the booster DC voltage source (3B) to the different coupling units (5, 5′, 5″) depending on the respective power or voltage requirement of electric vehicles (4, 4′, 4″) coupled to different coupling units (5, 5′, 5″) for charging.

5. The charging station of claim 4,
characterized in that
a plurality of booster DC voltage sources (3B) are present and the control unit (6) is designed
to connect the booster DC voltage sources (3B) in series in different configurations or to connect them in parallel in different configurations or to connect them partly in series and partly in parallel in different configurations depending on the respective DC charging voltage ranges (B) and the power or voltage requirement, in order to provide a power corresponding to the power requirement or a voltage corresponding to the voltage requirement at the coupling unit or units (5, 5′, 5″).

6. The charging station of claim 5,
characterized in that
the booster DC voltage source (3B) has an energy storage device, which in particular comprises or is a flywheel mass storage device.

7. The charging station of claim 6,
characterized in that
at least one of the standard DC voltage sources (3A, 3B) comprises an energy store, in particular all standard DC voltage sources (3A, 3B) comprise an energy store, the energy store or stores of the standard DC voltage sources (3A, 3B) having a lower deliverable power than the energy store of the booster DC voltage source.

8. The charging station of claim 7,
characterized in that
the control unit (6) is configured to connect the booster DC voltage source (3B) during a charging operation of the charging station (1), in which the electric vehicle (4) is being charged, and/or during a preparatory operation of the charging station (1), in which no electric vehicle (4) is being charged, in such a way that at a later time, which can be predetermined by a signal, a quantity of energy, which can also be predetermined by the signal, is deliverable for charging another electric vehicle in the energy store of the booster DC voltage source (3B).

9. The charging station of claim 8,
characterized in that
the control unit (6) is configured to keep the predeterminable amount of energy deliverable by connecting the booster DC voltage source (3B) in the charging operation in such a way that the amount of energy stored in the energy store does not fall below the predeterminable amount of energy.

10. The charging station of claim 10,
characterized in that
the control unit (6) is configured to use statistical data about a use of the charging station (1) for charging electric vehicles (4) and about a quantity of the supply current available via the electrical supply infrastructure for keeping the predeterminable quantity of energy deliverable, in particular in such a way that a predeterminable confidence is achieved for the availability of the predeterminable quantity of energy at the predeterminable later time.

11. A method for charging at least one electric vehicle (4) by using a charging station (1) with at least two direct-current voltage sources (3A, 3B) which are configured to provide an proportionate electrical power for charging the electric vehicle (4) by means of a direct-current charging voltage which can be set in a respective direct-current charging voltage range (A, B), wherein adjusting the DC charging voltages of the DC voltage sources (3A, 3B) for the charging and connecting the DC voltage sources (3A, 3B) for the charging is carried out depending on a power or voltage requirement of the electric vehicle (4) for the charging;
characterized in that the DC charging voltage range (B) of at least one of the DC voltage sources (3B), a booster DC voltage source, is different from the DC charging voltage range (A) of at least one of the at least one other DC voltage sources (3A), a standard DC voltage source, the DC charging voltage range (A) of the standard DC voltage source (3A) being at least partially outside the DC charging voltage range (B) of the booster DC voltage source (3B);
and connecting the booster DC voltage source (3B) with providing the proportional power assigned to the booster DC voltage source (3B) for charging the electric vehicle (4) exclusively when a voltage is set for charging the electric vehicle (4) which is in the DC charging voltage range (B) of the booster DC voltage source (3B).
